(19) United States
(12) Patent Application Publication
(10) Pub. No.: US 2006/0263167 A1
(43) Pub. Date: Nov. 23, 2006

(54) Expanding anchor made of metal and placing tool therefor

(76) Inventors: Martin Linka, Horb (DE); Oliver Hacker, Horb (DE)

Correspondence Address: Striker Striker & Stenby, 103 East Neck Road, Huntington, NY, 11743, US

(21) Appl. No.: 10/552,224

(22) PCT Filed: May 12, 2004
(86) PCT No.: PCT/EP04/05051

§ 371 Date: Oct. 6, 2005

(30) Foreign Application Priority Data
May 27, 2003 (DE) 103 24 005.5

(51) Int. Cl. F16B 13/06

(52) U.S. Cl. 411/60.3

(57) ABSTRACT

The invention relates to an expansible anchor (1) made of metal for affixing a component to a substrate. Known expansible anchors (1) have an anchor element (3) with fixing means (4) and an expansion zone (5) of reduced diameter which widens in the direction of insertion of the expansible anchor. An expansion sleeve (6) having expansion tongues (8) and at least one cutter (9) for creating an undercut is mounted on the expansion zone (5) so as to be axially displaceable. In order to reduce the manufacturing costs for such an expansible anchor (1), the invention proposes that the expansion sleeve (6) consists of hardened steel and the predetermined bending lines (10) are straight. The invention also proposes a setting tool (2) for setting such an expansible anchor (1), which has key-surfaces (16), a driving surface (17) and an adapter device (18).

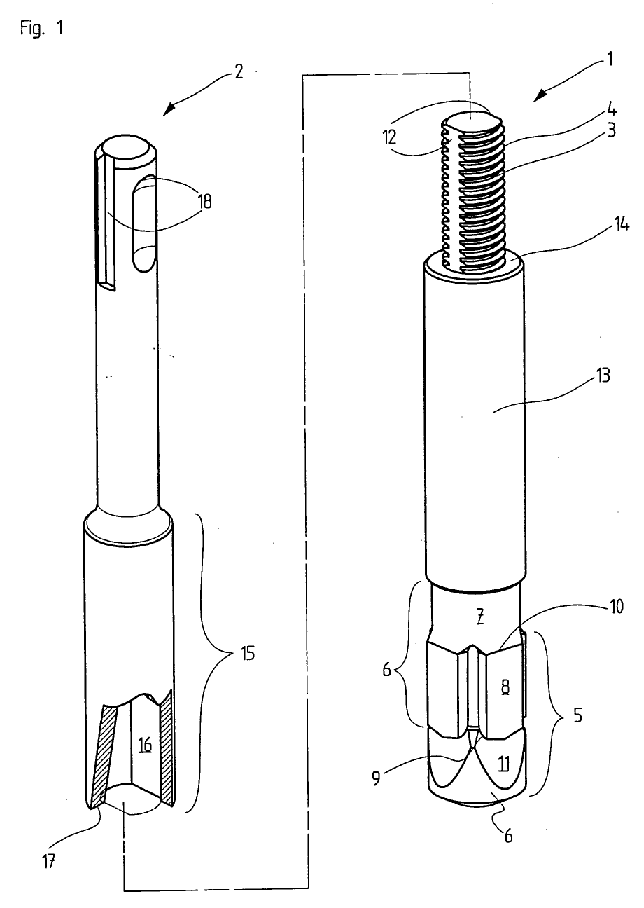

### The invention relates to an expansible anchor made of metal, having the features of the precharacterizing clause of claim 1.

Such an expansible anchor for affixing a component to a substrate is known from EP 0 217 053 B1. The known expansible anchor has an anchor element having an external thread as fixing means and an expansion zone of reduced diameter which widens conically in the direction of insertion of the expansible anchor. An expansion sleeve is mounted on that expansion zone so as to be axially displaceable. The expansion sleeve has a body on which forwardly projecting expansion tongues are formed along a predetermined bending line. Pushing the expansion sleeve onto the expansion zone causes the expansion tongues to be spread apart in order to anchor the expansible anchor in an undercut. The expansion sleeve has cutters on the front ends of the expansion tongues facing the base of the drilled hole, by means of which the undercut can be produced. For that purpose, the known expansible anchor is introduced into a cylindrical drilled hole and the expansion sleeve is driven onto the expansion element and at the same time set in rotation, for example using a hammer drill. As a result, material is removed radially to form a widened area in the drilled hole. For forming the cutters, cutter inserts of hard metal are proposed. However, the insertion and fixing of those cutter inserts in the expansion tongues, in addition to the cost of the materials, requires a considerable level of manufacturing costs. As a mass-produced product, the expansible anchor is therefore expensive. If, however, the inserts are omitted from the known form of the expansible anchor and it is instead attempted to impart sufficient hardness and strength to the entire material of the expansion sleeve so that the cutters can be formed on the expansion tongues themselves, such an attempt is unsuccessful because when the expansion tongues are spread apart they often tear or break off along the predetermined bending line. The reason for this is that the predetermined bending lines, as in all known expansible anchors, are curved on account of the shape of the sleeve. The desired outward buckling of the expansion tongues is thus rendered more difficult, because the curve has a stabilising effect. In order to buckle outwards the material needs to be substantially deformed, which requires a suitable degree of ductility and low wall thicknesses, but that is precisely contrary to the hardness required of the cutters in order to ensure the effectiveness of the cutters even in high-strength concrete.

The problem underlying the invention is therefore to provide an expansible anchor of the kind mentioned at the beginning which, while having the same or an improved level of efficiency, has lower manufacturing costs.

That problem is solved according to the invention by the expansible anchor having the features of claim 1 and by the setting tool having the features of claim 6. The expansible anchor according to the invention has an expansion sleeve of hardened steel. In order to avoid the mentioned problems of failure along the predetermined bending line, the bending line is straight. The crucial advantage of the invention lies in that difference. Considerably lower forces are required in order to buckle the expansion tongues outwards and those forces are distributed substantially more homogeneously along the predetermined bending line. The expansion sleeve can thus be made of a hard, high-strength material, which is accordingly more brittle than the materials used hitherto. It is also possible for a greater wall thickness to be chosen for the expansion sleeve, especially in the region of the predetermined bending line. Preferably, the expansion sleeve is in the form of a bent stamped component which is hardened after shaping and then mounted.

In a preferred embodiment, the expansion zone has flat slide surfaces for each expansion tongue. Four slide surfaces and expansion tongues allow easy manufacture but a larger or smaller number is also possible. Flat slide surfaces have the advantage on the one hand that the expansion tongues are surface-guided, whereas a rotationally symmetrical conical expansion zone would result in contact along a line. Surface guidance in turn results in a homogeneous distribution of stress in the region of the predetermined bending line. On the other hand, a considerable advantage is that the transmission of the torque for the rotational movement of the cutters can be effected by way of the anchor element. Whereas, in the known expansible anchors, the expansion sleeve has to be driven by a sleeve-like setting tool by means of drive claws, in this construction of the invention such transmission of the torque, which is susceptible to faults, is unnecessary. Instead, the anchor element can be set in rotation by means of a stable tool, the flat slide surfaces effecting the drive of the expansion tongues. The expansion sleeve needs merely to be displaced axially relative to the rotating anchor element. Preferably, an expansible anchor having such a structure has a spacer sleeve which serves for transmitting the blows of a setting tool to the expansion sleeve for the axial displacement thereof. It will be understood that the two sleeves can also be made in one piece. A separate spacer sleeve has the advantage, however, that the comparatively expensive material of the expansion sleeve is used only for the region necessary for that purpose. If the expansion sleeve is produced as a bent stamped component, then, in addition, the diameter selected for the expansion sleeve can be smaller than the nominal diameter in order to avoid unnecessary friction along the wall of the drilled hole. The spacer sleeve, which, in contrast, need not co-rotate, can be given the nominal diameter in order to provide the expansible anchor with play-free transverse force absorption.

In the case of flat slide surfaces, the anchor element preferably has key-engagement surfaces in the region of the fixing means. When an external thread is used as fixing means, those surfaces can be, for example, in the form of two lateral flattened portions or, when an internal thread is used as fixing means, in the form of two lateral grooves. Care should be taken that supportive thread portions are retained to a sufficient extent.

In order to be able to set such an expansible anchor in position, the invention proposes a setting tool which has suitable key-surfaces as well as a driving surface and an adapter device for seating the setting tool in, for example, a hammer drill. To set the expansible anchor in position, it is placed onto the setting tool by its anchor element, the key-engagement surfaces and key-surfaces coming into mutual engagement. In the mounted state, the driving surface is seated on the expansion sleeve or, if present, the spacer sleeve. The expansible anchor is then introduced into the drilled hole until it is seated on the base thereof. By means of a rotational/hammer movement of the tool, generated, for example, by a hammer drill, the anchor element and therewith the cutters on the expansion sleeve are set in rotation and at the same time the expansion sleeve is driven over the expansion zone of the anchor element. The rotational movement has the effect that the cutters remove material and thus create an undercut in the drilled hole. When expansion is complete, the setting tool is removed.

In an embodiment of the setting tool for expansible anchors having an external thread, the tool has a sleeve-like body part having the key-surfaces on the inner side and the driving surface on the end face. A very simple structure is obtained as a result. For expansible anchors having an internal thread, a bolt-like body part having key-surfaces on the outer side, for example in the form of a rectangular cross-section, would be possible, that body part being adjoined axially by a shoulder for forming the driving surface.

The invention will be described in greater detail below with reference to an embodiment shown in the drawing. The Figure shows an expansible anchor 1 according to the invention made of metal as well as a setting tool 2 according to the invention. The expansible anchor 1 serves for affixing an article (not shown) to a substrate (likewise not shown). The expansible anchor 1 has an anchor element 3 having an external thread 4 as fixing means for the article and an expansion zone 5 of reduced diameter which widens conically in the direction of the end 6 of the anchor. An expansion sleeve 6, manufactured as a bent stamped component, of hardened steel having a body 7 and four expansion tongues 8 is mounted on the expansion zone 5 so as to be axially displaceable. Axial displacement in the direction towards the end 6 of the anchor causes the expansion tongues 8 to be expanded radially outwards against the wall of the drilled hole. The expansion tongues 8 have cutters 9 for creating an undercut. The expansion tongues 8 are attached to the body 7 by way of straight predetermined bending lines 10. As a result, the expansion tongues 8 are able to buckle slightly outwards without the hardened steel being fractured. This is additionally assisted by the four flat slide surfaces 11. These also have the effect that a torque can be transmitted from the anchor element 3 to the expansion sleeve 6. In order that this torque can be transmitted to the anchor element 3 by a tool, here the setting tool 2, the anchor element has key-engagement surfaces 12. For transmission of an axial force to the expansion sleeve 6, the expansible anchor 1 has a spacer sleeve 13 having an end face 14. The spacer sleeve 13 serves in addition for the transverse support of the expansible anchor 1 in the drilled hole and therefore corresponds in diameter to the nominal diameter.

The setting tool 2 has a sleeve-like body part 15 having key-surfaces 16 on the inner side and a driving surface 17 on the end face for the transmission of impacts to the end face 14 of the spacer sleeve 13. For being received in, for example, a hammer drill (not shown), the setting tool 2 has an adapter device 18 in the form of standard grooves.

For setting the expansible anchor 1 with the setting tool 2 clamped in a hammer drill, the expansible anchor 1 is inserted into the setting tool 2, so that the key-surfaces 16 enter into engagement with the key-engagement surfaces 12 and the driving surface 17 of the setting tool 2 is seated on the end face 14 of the spacer sleeve 13. In this state the expansible anchor 1 is inserted into a hole (not shown) drilled in a substrate until it is seated on the base of the drilled hole. By means of a combined rotational/hammer movement of the hammer drill, the anchor element 3 and therewith the expansion sleeve 6 are set in rotation. At the same time, the expansion sleeve 6 is displaced axially on the expansion zone 5 and as a result the expansion tongues 8 are expanded radially outwards along the slide surfaces 11. By rotation of the expansion sleeve 6, the cutters 9 remove material to form a radial widened area in that region of the drilled hole. That widened portion acts as an undercut. As a result, interlocking anchoring in the drilled hole is achieved. After the setting operation, the setting tool 2 is simply removed from the expansible anchor 1.

1. Expansible anchor (1) made of metal for affixing a component to a substrate, the expansible anchor (1) having an anchor element (3) with fixing means (4) and an expansion zone (5) of reduced diameter which widens in the direction of insertion of the expansible anchor, on which an expansion sleeve (6) having expansion tongues (8) and at least one cutter (9) for creating an undercut is mounted so as to be axially displaceable, the expansion tongues (8) each being connected along a predetermined bending line (10) to the body (7) of the expansion sleeve (6), characterized in that the expansion sleeve (6) consists of hardened steel and the predetermined bending lines (10) are straight.

2. Expansible anchor according to claim 1, characterized in that the expansion sleeve (6) is a bent stamped component.

3. Expansible anchor according to claim 1, characterized in that the widening portion of the expansion zone (5) has flat slide surfaces (11).

4. Expansible anchor according to claim 1, characterized in that the expansible anchor (1) has a spacer sleeve (13).

5. Expansible anchor according to claim 1, characterized in that the anchor element (3) has key-engagement surfaces (12) in the region of the fixing means (4).

6. Setting tool (2) for setting an expansible anchor (1), especially according to claim 5, characterized in that the setting tool (2) has key-surfaces (16) corresponding to the key-engagement surfaces (12) of the expansible anchor (1), a driving surface (17) and an adapter device (18).

7. Setting tool according to claim 6, characterized in that the setting tool (2) has a sleeve-like body part (15) having the key-surfaces (16) on the inner side and the driving surface (17) on the end face.
